(19) United States
(12) Patent Application Publication
(10) Pub. No.: US 2014/0160125 A1
(43) Pub. Date: Jun. 12, 2014

(54) APPARATUS AND METHOD FOR RENDERING BEZIER CURVE

(71) Applicant: SAMSUNG ELECTRONICS CO., LTD., Suwon-si (KR)

(72) Inventors: Jeong Joon YOO, Hwaseong-si (KR); Seung Won Lee, Hwaseong-si (KR); Shi Hwa Lee, Seoul (KR); Seok Yoon Jung, Seoul (KR)

(73) Assignee: SAMSUNG ELECTRONICS CO., LTD., Suwon-si (KR)

(21) Appl. No.: 13/890,720

(22) Filed: May 9, 2013

(30) Foreign Application Priority Data
Dec. 7, 2012 (KR) 10-2012-0142007

(51) Int. Cl. G06T 15/10

(52) U.S. Cl. CPC G06T 15/10
USPC 345/423

(57) ABSTRACT

An apparatus and method for rendering a tile-binned Bezier curve may include a rendering calculator to determine a rendering scheme for at least one tile, with respect to the tile-binned Bezier curve, and a rendering processor to perform rendering with respect to a Bezier curve for the at least one tile, based on the determined rendering scheme. The rendering calculator may suspend the rendering of the Bezier curve at a boundary point between the at least one tile and an adjacent tile while the rendering is being performed, and determine the rendering scheme for a boundary value in which a position of the boundary point is reflected to be used when the adjacent tile is rendered.

### CROSS-REFERENCE TO RELATED APPLICATIONS

This application claims the priority benefit of Korean Patent Application No. 10-2012-0142007, filed on Dec. 7, 2012, in the Korean Intellectual Property Office, the disclosure of which is incorporated herein by reference.

### BACKGROUND

1. Field

Example embodiments relate to rendering a Bezier curve by removing a duplicated computation performed for each tile when tile-based rendering (TBR) is performed.

2. Description of the Related Art

A size of three-dimensional (3D) graphic data is large. Accordingly, there is a demand for a method of reducing a memory bandwidth when processing such data.

An embedded system, for example, a mobile product, requires such a method of reducing a memory bandwidth. In industry, Imagination is employing tile-based rendering (TBR), as a method of processing 3D graphics, for mobile products.

The TBR refers to a method of dividing a screen into multiple tiles, and displaying graphic data on the screen on a tile by tile basis. Such rendering may process 3D graphic data by loading only 3D graphic data included in a tile to a fast performance on-chip memory. Accordingly, an access to an external memory may be reduced and thus, a required memory bandwidth may be reduced.

In general, when an internal memory is accessed, in lieu of an external memory, the power consumption may be reduced by a factor of about ten and thus, a longer battery life may be provided.

In order to draw curves included in a tile, a process of examining figures included in a current tile in advance may be necessary.

Such a process may be referred to as tile binning, in which information regarding tiles overlapping outer bounding boxes may be generated through the bounding boxes surrounding the figures being generated, respectively, and the information regarding the tiles overlapping the generated bounding boxes may be stored in a data structure called a tile bin or a tile binner.

The tile-binned Bezier curves may be drawn when respective tiles are rendered.

### SUMMARY

The foregoing and/or other aspects are achieved by providing a tile-based curve rendering apparatus for rendering a tile-binned Bezier curve, in which the apparatus may include a rendering calculator to determine a rendering scheme for at least one tile, with respect to the tile-binned Bezier curve, and a rendering processor to perform rendering with respect to a Bezier curve for the at least one tile, based on the determined rendering scheme. Here, the rendering calculator may suspend the rendering of the Bezier curve at a boundary point between the at least one tile and an adjacent tile while the rendering is being performed, and determine the rendering scheme for a boundary value in which a position of the boundary point is reflected to be used when the adjacent tile is rendered.

The rendering calculator may verify whether at least one of a start control point, an extremal value point, and an end control point of the Bezier curve is present in a tile to be rendered.

When at least one of a start control point and an end control point of the Bezier curve is present in a tile to be rendered, the rendering calculator may determine the rendering scheme for the rendering of the Bezier curve to be terminated on at least one of the start control point and the end control point.

When an extremal value point of the Bezier curve is present in a tile to be rendered, the rendering calculator may determine the rendering scheme for the rendering of the Bezier curve to be performed, starting from the extremal value point to at least one of the boundary point between the at least one tile and an adjacent tile, a start control point, and an end control point.

The rendering calculator may verify whether coordinates of the extremal value point are present in the tile to be rendered, using a ratio of the extremal value point to three points constituting the Bezier curve.

The rendering calculator may determine the rendering scheme for the Bezier curve to be rendered starting from the boundary value, when the Bezier curve is rendered in the adjacent tile.

The foregoing and/or other aspects are achieved by providing a tile-based curve rendering method performed by an apparatus for rendering a tile-binned Bezier curve, in which the method may include determining, by a rendering calculator, a rendering scheme for at least one tile, with respect to the tile-binned Bezier curve, and performing, by a rendering processor, rendering with respect to a Bezier curve for the at least one tile, based on the determined rendering scheme. Here, the determining may include suspending the rendering of the Bezier curve at a boundary point between the at least one tile and an adjacent tile while the rendering is being performed, and determining the rendering scheme for a boundary value in which a position of the boundary point is reflected to be used when the adjacent tile is rendered.

The determining may include verifying whether at least one of a start control point, an extremal value point, and an end control point of the Bezier curve is present in a tile to be rendered.

The determining may include, when at least one of a start control point and an end control point of the Bezier curve is present in a tile to be rendered, determining the rendering scheme for the rendering of the Bezier curve to be terminated on at least one of the start control point and the end control point.

The determining may include, when an extremal value point of the Bezier curve is present in a tile to be rendered, determining the rendering scheme for the rendering of the Bezier curve to be performed, starting from the extremal value point to at least one of the boundary point between the at least one tile and an adjacent tile, a start control point, and an end control point.

The determining may include verifying whether coordinates of the extremal value point are present in the tile to be rendered, using a ratio of the extremal value point to three points constituting the Bezier curve.

The determining may include determining the rendering scheme for the Bezier curve to be rendered starting from the boundary value, when the Bezier curve is rendered in the adjacent tile.

Additional aspects and/or advantages of one or more embodiments will be set forth in part in the description which follows and, in part, will be apparent from the description, or may be learned by practice of one or more embodiments of disclosure. One or more embodiments are inclusive of such additional aspects.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates a tile-based rendering (TBR) pipeline according to one or more example embodiments;

FIG. 2 illustrates a tile-based curve rendering apparatus according to one or more example embodiments;

FIG. 3 illustrates an example of rendering a tile for a case in which a start control point and an end control point are present in the tile according to one or more example embodiments;

FIG. 4 illustrates an example of rendering a tile for a case in which a start control point and an end control point are present in an adjacent tile according to one or more example embodiments;

FIG. 5 illustrates an example of rendering a tile for a case in which a start control point is present in the tile according to one or more example embodiments;

FIG. 6 illustrates an example of rendering a tile for a case in which a start control point is present in an adjacent tile according to one or more example embodiments;

FIG. 7 illustrates an example of rendering a tile for a case in which an extremal value point is present in the tile according to one or more example embodiments;

FIG. 8 illustrates an example of rendering a tile for a case in which an extremal value point is present in an adjacent tile according to one or more example embodiments;

FIG. 9 illustrates an example of deriving at value (t=α) at an instant of rendering an extremal value point of a Bezier curve according to one or more example embodiments;

FIG. 10 illustrates a detailed configuration of a tile-based curve rendering apparatus according to one or more example embodiments;

FIG. 11 illustrates a tile-based curve rendering method according to one or more example embodiments;

FIG. 12 illustrates a detailed operation of determining whether a point to be rendered corresponds to an end control point in a tile-based curve rendering method according to one or more example embodiments, such as the tile-based curve rendering method of FIG. 11;

FIG. 13 illustrates an operating method of a T generator according to one or more example embodiments, such as the T generator of FIG. 10; and

FIG. 14 illustrates an operating method of a Bezier calculator according to one or more example embodiments, such as the Bezier calculator of FIG. 10.

### DETAILED DESCRIPTION

Reference will now be made in detail to one or more embodiments, illustrated in the accompanying drawings, wherein like reference numerals refer to like elements throughout. In this regard, embodiments of the present invention may be embodied in many different forms and should not be construed as being limited to embodiments set forth herein, as various changes, modifications, and equivalents of the systems, apparatuses and/or methods described herein will be understood to be included in the invention by those of ordinary skill in the art after embodiments discussed herein are understood. Accordingly, embodiments are merely described below, by referring to the figures, to explain aspects of the present invention.

When it is determined that a detailed description is related to a related known function or configuration which may make the purpose of the present disclosure unnecessarily ambiguous in the description, such a detailed description will be omitted. Also, terminologies used herein are defined to appropriately describe the exemplary embodiments and thus may be changed depending on a user, the intent of an operator, or a custom. Accordingly, the terminologies must be defined based on the following overall description of this specification.

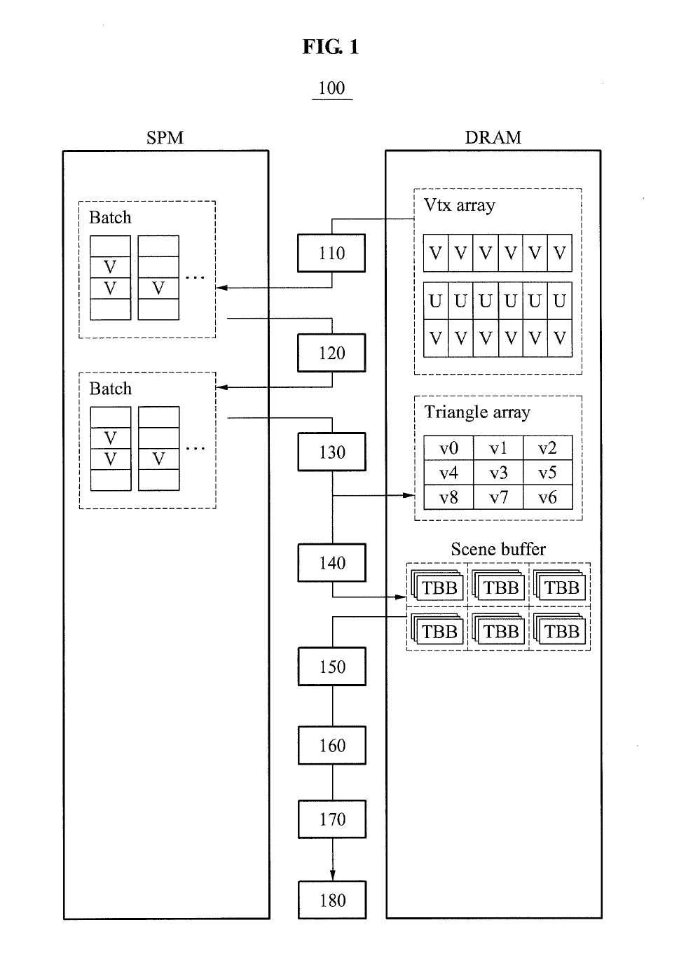

FIG. 1 illustrates a tile-based rendering (TBR) pipeline 100 according to one or more example embodiments.

Referring to FIG. 1, a batch management unit (BMU) 110 may receive an input of three-dimensional (3D) graphic data, for example, a vertex (Vtx) array, and divide the graphic data into groups on a batch basis.

A vertex shader (VS) 120 may load a single batch, and convert the batch into coordinates on a screen with respect to a single piece of vertex data.

A primitive assembler (PA) 130 may combine respective points to form a triangle.

A tile binner (TB) 140 may perform tile binning with respect to triangles, respectively.

In addition, the TB 140 may perform the tile binning with respect to a Bezier curve.

The TB 140 may identify the Bezier curve from input data, and perform the tile binning differently depending on whether the identified Bezier curve corresponds to a stroked curve or a filled curve.

As an example, when the identified Bezier curve corresponds to the stroked curve, the TB 140 may generate a plurality of bounding boxes corresponding to the stroked curve.

In addition, the TB 140 may perform the tile binning with respect to the identified Bezier curve, using the generated plurality of bounding boxes.

As another example, when the identified Bezier curve corresponds to the filled curve, the TB 140 may generate a tight bounding box for the filled curve.

The TB 140 may perform the tile binning, using the generated plurality of bounding boxes or the generated tight bounding box.

A tile may refer to a unit of a screen generated by dividing a display area into small pieces. The tile binning may refer to a process of investigating a tile of the display area in which a triangle, a Bezier curve, and the like may be included, and data-structuring the information.

A tile dispatching unit (TDU) 150 may distribute a plurality of graphic processing units to process the 3D graphic data by dividing the display area into tile units, when the plurality of graphic processing unit is provided.

A fragment generator (FG) 160 may perform rendering with respect to the triangle, the Bezier curve, and the like included in each tile, based on a data structure of the tile binning.

In particular, the FG 160 may determine a color of a pixel, a depth of the pixel, and the like.

A pixel shader (PS) 170 may determine a final color combined with a color of a current pixel, based on an alpha value indicating a transparency and a color received from a texture.

A raster operation (ROP) 180 may determine whether the 3D graphic data is to be displayed on the final display area, by performing a depth test, an alpha test, and the like. The 3D graphic data may be rendered on the display area, through the process described above.

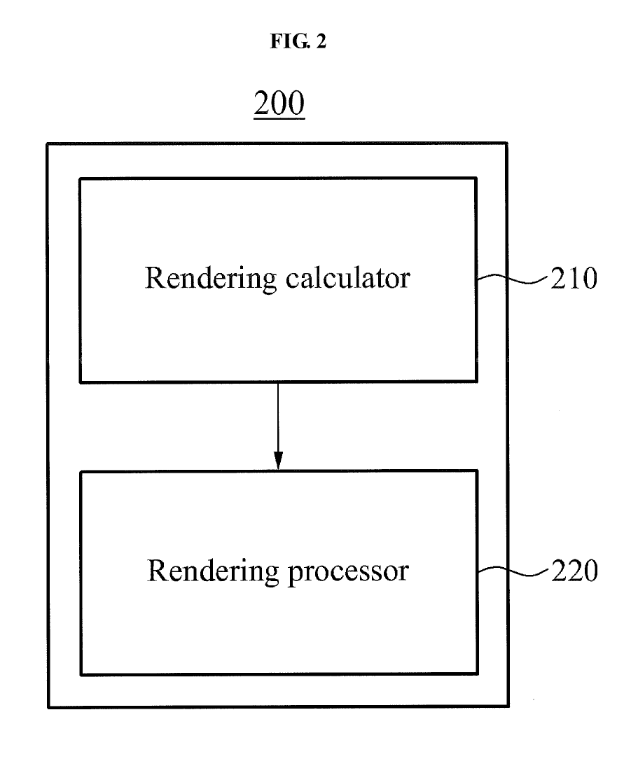

FIG. 2 illustrates a tile-based curve rendering apparatus 200 according to one or more example embodiments.

The apparatus 200 may render a Bezier curve on a tile by tile basis, wherein the tile constitutes a a portion of a display area.

In addition, the apparatus 200 may identify a shape of the Bezier curve using values of multiple control points, and render the Bezier curve, starting from a start control point or an end control point of the Bezier curve.

Further, the apparatus 200 may perform the rendering at an extremal value point, other than the start control point or the end control point.

To this end, referring to FIG. 2, the apparatus 200 may include a rendering calculator 210, and a rendering processor 220.

The rendering calculator 210 may determine a rendering scheme for at least one tile, with respect to a tile-binned Bezier curve.

The rendering processor 210 may perform rendering with respect to a Bezier curve for the at least one tile, based on the determined rendering scheme.

The rendering calculator 210 may determine the rendering scheme for duplicated computation of the Bezier curve to be removed.

To this end, the rendering calculator 210 may suspend the rendering of the Bezier curve at a boundary point between the at least one tile and an adjacent tile while rendering is being performed, and determine the rendering scheme for a boundary value in which a position of the boundary point is reflected to be used when the adjacent tile is rendered.

The rendering calculator 210 may verify whether at least one of a start control point, an extremal value point, and an end control point of the Bezier curve is present in a tile to be rendered.

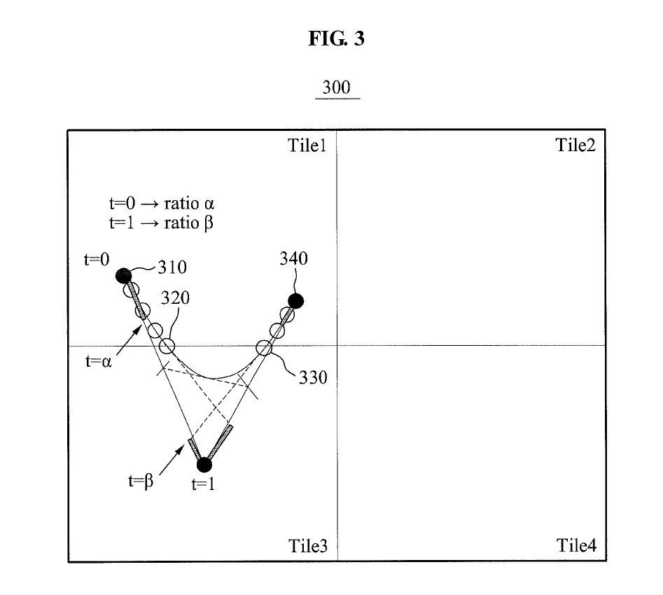

When at least one of the start control point and the end control point is present in a tile, the rendering calculator 210 may determine the rendering scheme to remove the duplicated computation of the Bezier curve, as shown in FIGS. 3 through 6.

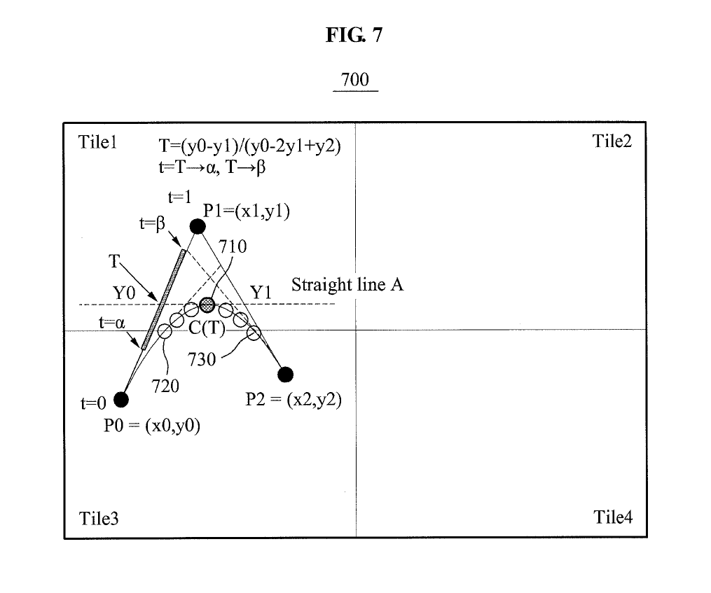

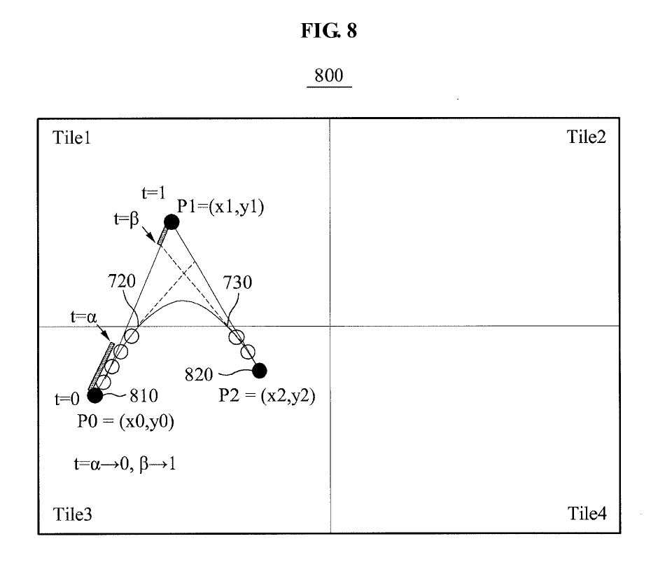

In addition, when the extremal value point is present in the tile, the rendering calculator 210 may determine the rendering scheme to remove the duplicated computation of the Bezier curve, as shown in FIGS. 7 through 8.

In particular, FIG. 3 illustrates an example 300 of rendering a tile for a case in which a start control point 310 and an end control point 340 are present in the tile according to one or more example embodiments.

Referring to FIG. 3, the rendering calculator 210 may identify a shape of the Bezier curve, and verify that both the start control point 310 and the end control point 340 are present in the tile 1 and that the extremal value point is absent from the tile 1.

The start control point may indicate a point at which t=0, and the end control point 340 may indicate a point at which t=1.

The extremal value point may refer to a point of an instant at which a gradient of a tangent touching the Bezier curve is changed from positive to negative or from negative to positive, for example, a point indicating an extremal value.

The rendering calculator 210 may suspend the rendering at a boundary point 320 between the tile 1 and the tile 3 while the rendering of the Bezier curve is being performed, and determine the rendering scheme for at value (t=α) at the boundary point 320 to be stored in a tile binner.

The rendering calculator 210 may determine the rendering scheme for the t value (t=a) at the boundary point 320, stored in the tile binner, to be used when the tile 3 is rendered.

The rendering calculator 210 may suspend the rendering at a boundary point 330 between the tile 1 and the tile 3 while the rendering of the Bezier curve is being performed inversely, starting from the end control point 340, and determine the rendering scheme for at value (t=β) at the boundary point 330 to be stored in the tile binner.

When at least one of a start control point and an end control point of the Bezier curve is present in a tile to be rendered, the rendering calculator 210 may determine the rendering scheme for the rendering of the Bezier curve to be terminated on at least one of the start control point and the end control point.

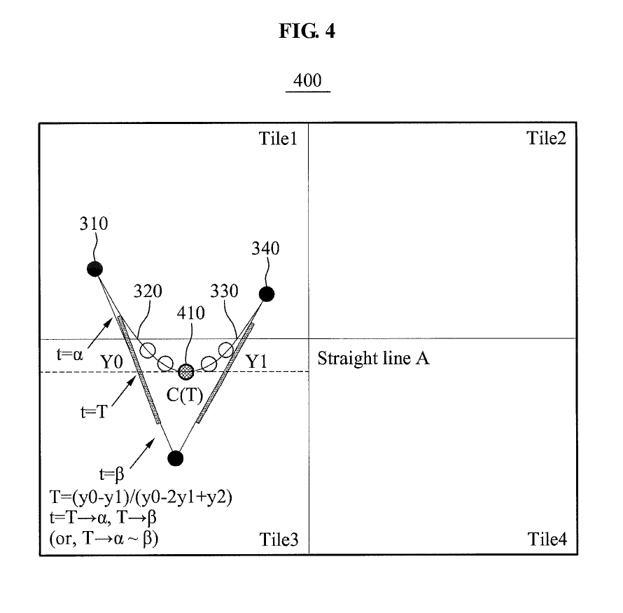

FIG. 4 illustrates an example 400 of rendering a tile for a case in which a start control point and an end control point are present in an adjacent tile according to one or more example embodiments.

When the rendering of the tile 1 is terminated, such as in FIG. 3, rendering of the tile 3 may proceed after rendering of a tile 2 is performed.

As shown in FIGS. 3 and 4, since the Bezier curve is absent in the tile 2, the rendering of the tile 3 may proceed after the rendering of the tile 1 is performed.

As described with reference to FIG. 3, the rendering of the Bezier curve may be terminated at the boundary points 320 and 330 between the tile 1 and the tile 3, and the values t at the boundary points 320 and 330 may be stored in the tile binner.

The rendering calculator 210 may determine the rendering scheme for the rendering of the Bezier curve to proceed in the tile 3, starting from a point at which t=α to a point at which t=β.

In tile 3, an extremal value point 410 of the Bezier curve may be present.

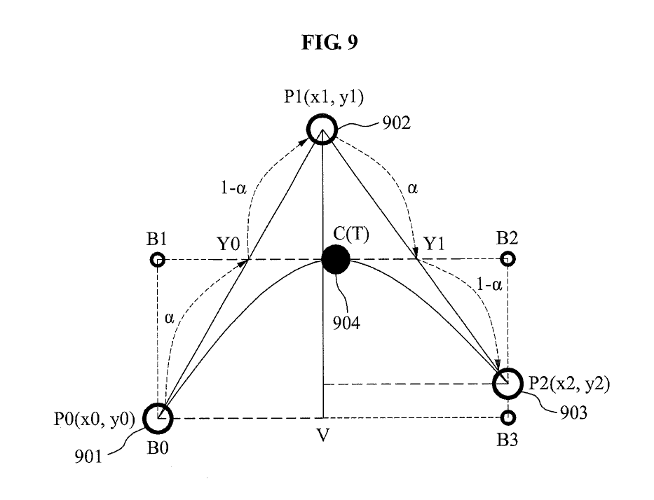

An extremal value C(T) of the extremal value point 410 may be expressed by “(y0−y1)/(y0−2y1+y2)”. Expression of the extremal value point 410 will be described in detail with reference to FIG. 9.

The rendering processor 220 may perform the rendering with respect to the Bezier curve for at least one tile, based on the determined rendering scheme, when the rendering scheme is determined.

Partitioning of the Bezier curve and duplication of Bezier computation for each tile may be omitted and thus, an effective performance may be provided when the apparatus 200 is used.

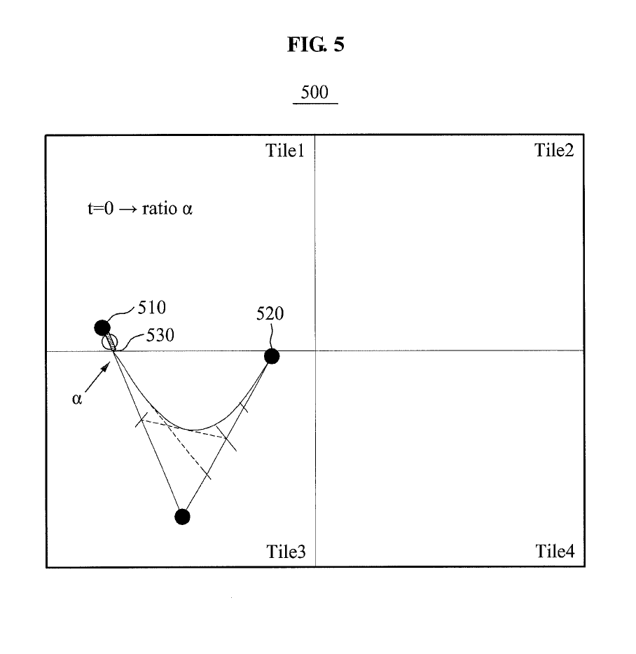

FIG. 5 illustrates an example 500 of rendering a tile for a case in which a start control point is present in the tile according to one or more example embodiments.

Referring to FIG. 5, the rendering calculator 210 may identify a shape of a Bezier curve using values of multiple control points, and render the Bezier curve, starting from a start control point or an end control point of the Bezier curve.

As shown in the Bezier curve of FIG. 5, the rendering calculator 210 may verify that a start control point 510 is included in the tile 1, and an end control point 520 is included in the tile 3.

The rendering calculator 210 may determine a rendering scheme for the rendering to be suspended at a boundary point 530 between the tile 1 and the tile 3, while the rendering of the tile 1 is being performed starting from the start control point 510.

In addition, the rendering calculator 210 may determine the rendering scheme for at value at the boundary point 530 to be used when the tile 3 is rendered, by storing the t value at the boundary point 530 in a tile binner.

The rendering processor 220 may perform the rendering with respect to the Bezier curve for the at least one tile, based on the determined rendering scheme, when the rendering scheme is determined.

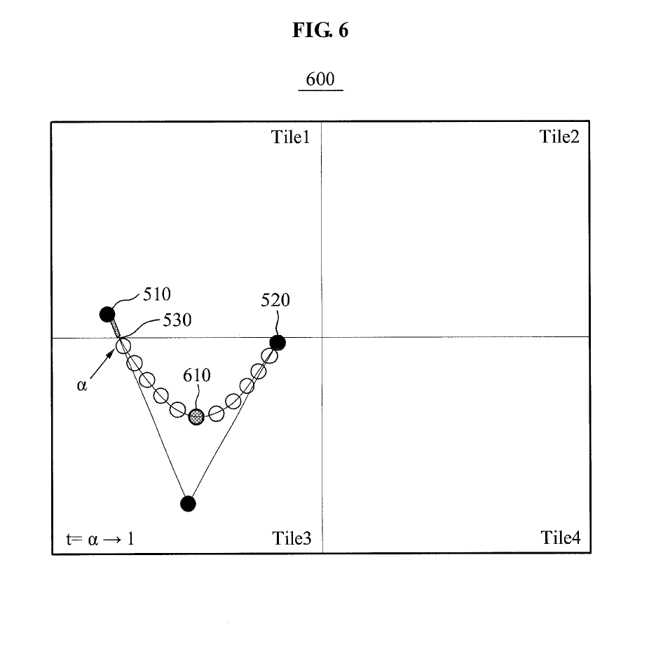

FIG. 6 illustrates an example 600 of rendering a tile for a case in which a start control point is present in an adjacent tile according to one or more example embodiments.

Referring to FIG. 6, the rendering calculator 210 may verify the boundary point 530 from the tile binner while the rendering of the tile 3 is being performed, and determine the rendering scheme for the rendering of the Bezier curve to be performed starting from the boundary point 530.

The rendering calculator 210 may determine the rendering scheme for the rendering to be suspended at the end control point 520, passing by an extremal value point 610 while the rendering of the Bezier curve is being performed.

The rendering processor 220 may perform the rendering with respect to the Bezier curve for the at least one tile, based on the determined rendering scheme, when the rendering scheme is determined.

FIG. 7 illustrates an example 700 of rendering a tile for a case in which an extremal value point is present in the tile according to one or more example embodiments.

Referring to FIG. 7, when an extremal value point of the Bezier curve is present in a tile to be rendered, the rendering calculator 210 may determine the rendering scheme for the rendering of the Bezier curve to be performed, starting from the extremal value point to at least one of a boundary point between the tile to be rendered and an adjacent tile, a start control point, and an end control point.

In particular, the rendering calculator 210 may calculate t=T at the extremal value point, and determine at value (t=α) at a first boundary point 720 at which the Bezier curve touches the tile 3 and at value (t=β) at a second boundary point 730 at which the Bezier curve touches the tile 3.

In addition, the rendering calculator 210 may determine the rendering scheme for the rendering of the Bezier curve to be performed, starting from the extremal value point to the first boundary point 720, and starting from the extremal value point to the second boundary point 730.

Further, the rendering calculator 210 may store the t value (t=α) at the first boundary point 720 and the t value (t=β) at the second boundary point 730 in a tile binner, to be used for rendering the tile 3.

The rendering processor 220 may perform the rendering with respect to the Bezier curve for the at least one tile, based on the determined rendering scheme, when the rendering scheme is determined.

FIG. 8 illustrates an example 800 of rendering a tile for a case in which an extremal value point is present in an adjacent tile according to one or more example embodiments.

Referring to FIG. 8, while the rendering of the tile 1 is being performed, the rendering calculator 210 may store the t value (t=α) at the first boundary point 720 and the t value (t=β) at the second boundary point 730 in the tile binner, to be used for rendering the tile 3.

The rendering calculator 210 may determine the rendering scheme for the rendering of the tile 3 to be performed, starting from a start control point 810 to the first boundary point 720 at which t=α, and starting from an end control point 820 to the second boundary point 730 at which t=II

The rendering processor 220 may perform the rendering with respect to the Bezier curve for the at least one tile, based on the determined rendering scheme, when the rendering scheme is determined.

FIG. 9 illustrates an example of calculating an extremal value point of a Bezier curve according to one or more example embodiments.

A rendering calculator may verify whether coordinates of the extremal value point are present in a tile to be rendered, using a ratio of the extremal value point to three points constituting the Bezier curve.

A tile-based curve rendering apparatus may initiate rendering at the extremal value point, other than a start control point or an end control point.

To this end, the tile-based curve rendering apparatus may calculate a time t at the extremal value point of the Bezier curve.

In FIG. 9, when the extremal value point of the Bezier curve is calculated, at value (t=α) at an instant of rendering the extremal value point may be determined.

A first control point corresponding to a start control point and a second control point corresponding to an end control point may be provided as control points for curve generation, and an extremal value C(T) may be calculated, as shown in FIG. 9.

In order to calculate the extremal value C(T) of the Bezier curve, a characteristic of the Bezier curve described with respect to FIG. 9 may be used.

In particular, a proportional analysis of a line length using the characteristic of the Bezier curve is illustrated in FIG. 9.

Referring to FIG. 9, relational expressions of Equation 1 may be derived based on the characteristic of the Bezier curve.

### [Equation 1]

α: 1−α=(Y0−y0):y1−Y0 (1)

α: 1−α=(y1−Y1):Y1−y2 (2)

In Equation 1, α denotes a time necessary for movement from a point B0 901 to a point Y0, or a time necessary for movement from a point P1 902 to a point Y1. In addition, 1−α denotes a time necessary for movement from the point Y0 to the point P1 902, or a time necessary for movement from the point Y1 to a point P2 903.

Y0−y0 may be construed as a Y-coordinate length from an extremal value C(T) 904 to V, and y1−Y0 may be construed as a Y-coordinate length from the point P1 902 to the extremal value C(T) 904.

The relational expression (1) of Equation 1 may be arranged based on Y0, as expressed by Equation 2.

(1−α)(Y0−y0)=α(y1−Y0)

(Y0−y0)−α(Y0−y0)=α(y1−Y0)

Y0−αY0=α(y1−Y0)+y0−αy0

Y0=y0−αy0+αy1 [Equation 2]

In Equation 2, α denotes a time necessary for moving from the point B0 901 to the point Y0, or a time necessary for moving from the point P1 902 to the point Y1. In addition, 1−αdenotes a time necessary for movement from the point Y0 to the point P1 902, or a time necessary for movement from the point Y1 to the point P2 903. Y0−y0 may be construed to be a Y-coordinate length from the extremal value C(T) 904 to V, and y1−Y0 may be construed to be a Y-coordinate length from the point P1 902 to the extremal value C(T) 904.

In addition, the relational expressions of Equation1 may be arranged based on Y1, as expressed by Equation 3.

α:1−α=(y1−Y1):Y1−y2

α(Y1−y2)=(1−α)(y1−Y1)

αY1−αy2+(1−α)Y1=(1−α)y1

Y1=y1−αy1+ay2 [Equation 3]

In Equation 3, α denotes a time necessary for moving from the point B0 901 to the point Y0, or a time necessary for moving from the point P1 902 to the point Y1. In addition, 1−αdenotes a time necessary for moving from the point Y0 to the point P1 902, or a time necessary for moving from the point Y1 to the point P2 903. Y0−y0 may be construed as a Y-coordinate length from the extremal value C(T) 904 to V, and y1−Y0 may be construed as a Y-coordinate length from the point P1 902 to the extremal value C(T) 904.

Since a gradient with respect to an extremal value point at the Bezier curve corresponds to “0”, Y0 may be equal to Y1.

Accordingly, Y0 arranged in Equation 2 and Y1 arranged in Equation 3 may be equal, and may be expressed by Equation 4.

y0−αy0+αy1=y1−αy1+ay2 [Equation 4]

In Equation 4, α denotes a time necessary for movement from the point B0 901 to the point Y0.

Equation 4 may be arranged based on a, as expressed by Equation 5.

α=(y0−y1)/(y0−2y1+y2) [Equation 5]

In Equation 5, α denotes a time necessary for movement from the point B0 901 to the point Y0.

When the calculated value of α is substituted with Y0 of Equation 2 or Y1 of Equation 3, the extremal value C(t) for a quadratic Bezier curve may be defined, as expressed by Equation 6.

C(t)=(1−t)²P0+2(1−t)tP1+t²P2,tε[0, 1]

X(t)=(1−t)²x0+2(1−t)tx1+t²x2

Y(t)=(1−t)²y0+2(1−t)ty1+t²y2 [Equation 6]

Coordinates at the extremal t value of the Bezier curve may correspond to (X, Y), and at value at this instant may correspond to a value of α of Equation 5. Accordingly, an X coordinate at the extremal value may be calculated using X(t) of Equation 6.

Consequently, an equation with respect to the Bezier curve at the extremal value may be calculated, as expressed by Equation 7.

If C(t)=(X,Y),

t=(y0−y1)/(y0−2y1+y2)

Y=(y1−y0)(y0−y1)/(y0−2y1+y2)+y0

X=(1−t)²x0+2(1−t)tx1+t²x2

By applying a scheme of calculating coordinates with respect to C(t)=(X, Y), as expressed by Equation 7, coordinates (x0, y0) of a bounding box corresponding to coordinates facing C(t), and coordinates (x2, y2) of another bounding box corresponding to coordinates facing C(t) may be derived.

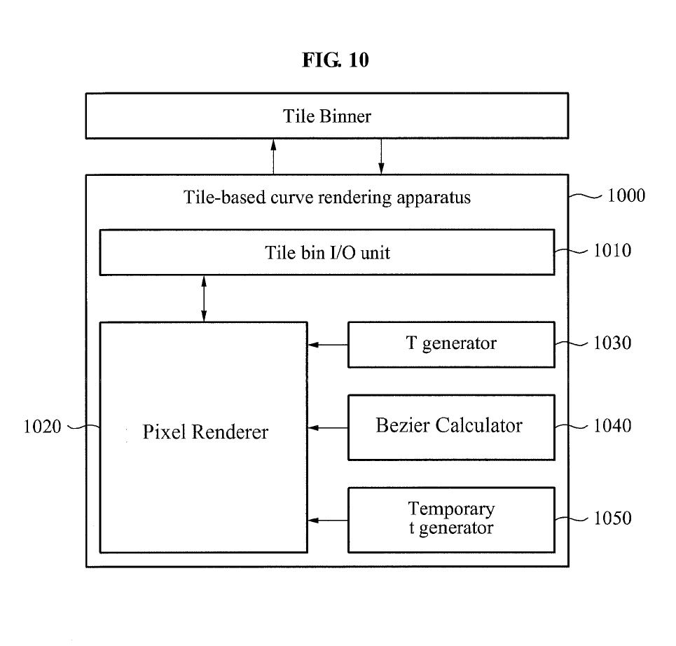

FIG. 10 illustrates a detailed configuration of a tile-based curve rendering apparatus according to one or more example embodiments.

Referring to FIG. 10, the apparatus 1000 may include a tile bin input and output (I/O) unit 1010, a pixel renderer 1020, a T generator 1030, a Bezier calculator 1040, and a temporary t generator 1050.

The pixel renderer 1020 may perform rendering with respect to a Bezier curve for at least one tile, based on a determined rendering method.

The T generator 1030, the Bezier calculator 1040, and the temporary t generator 1050 may determine the rendering scheme for the at least one tile, with respect to a tile-binned Bezier curve.

The T generator 1030 may generate an extremal value point C(T) on the Bezier curve, and the Bezier calculator 1040 may verify positions of a start control point, an end control point, and the extremal value point, thereby determining the rendering scheme for computation with respect to the Bezier curve in each tile to be performed.

The temporary t generator 1050 may enable at value at a point at which the Bezier curve touches a boundary point between tiles to be stored in a tile binner, through the pixel renderer 1020 and the tile bin I/O unit 1010.

In particular, in a tile-based rendering (TBR) pipeline structure, a route for storing a temporary t value in a tile bin of an adjacent tile may be added. Here, the temporary t value may be generated at a boundary point between a tile and the adjacent tile while the Bezier curve is being rendered, and be shared with the adjacent tile.

The tile bin I/O unit 1010 may receive information relating to the Bezier curve and the temporary t value from the tile binner, and store, in the tile bin, a new temporary t value generated at the boundary point between the tiles while the Bezier curve is being rendered.

While the Bezier curve is being rendered in the tile, the rendering of the Bezier curve may be suspended at the boundary point between the tile and the adjacent tile, and a time value t at the instant may be stored in a corresponding tile bin of another tile, for example, a neighbor tile, sharing the boundary point, and the corresponding time value t may be reused in the neighbor tile.

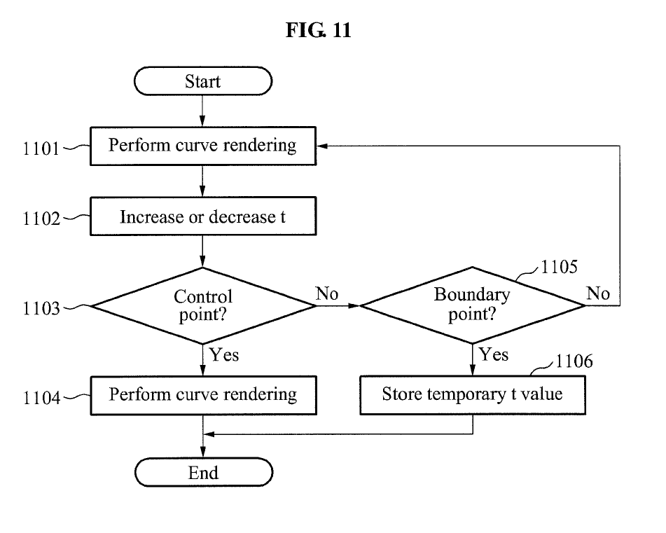

FIG. 11 illustrates a tile-based curve rendering method according to one or more example embodiments.

Referring to FIG. 11, in operation 1101, curve rendering in each partitioned tile may be performed.

In operation 1102, t may be increased or decreased to perform the curve rendering in each partitioned tile.

For example, when an initial position at which the curve rendering is performed corresponds to a start control point, t may be increased to perform the curve rendering. When the initial position at which the curve rendering is performed corresponds to an end control point, t may be decreased to perform the curve rendering.

In addition, when the initial position at which the curve rendering is performed corresponds to an extremal value point, t may be increased or decreased to perform the curve rendering.

t may be increased or decreased to suspend the curve rendering. Before the curve is rendered, whether a point to be rendered corresponds to the start control point or the end control point may be determined in operation 1103.

As a result of the operation 1103, when the point to be rendered is determined to correspond to the start control point or the end control point, the curve rendering may be performed in operation 1104, and terminated.

As the result of the operation 1105, when the point to be rendered on the Bezier curve corresponds to a boundary point, a temporary t value may be stored in a tile binner in operation 1106, and the rendering may be terminated.

As the result of the operation 1105, when the point to be rendered on the Bezier curve does not correspond to a boundary point, the operation 1101 may be performed to perform the curve rendering.

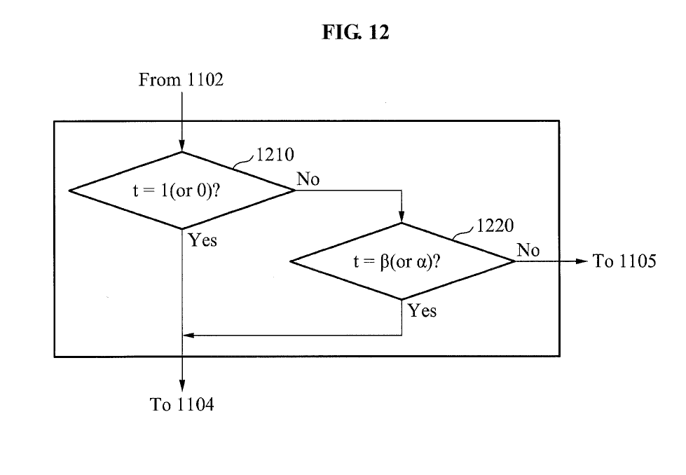

FIG. 12 illustrates a detailed operation of determining whether a point to be rendered corresponds to an end control point in a tile-based curve rendering method according to one or more example embodiments, such as the tile-based curve rendering method of FIG. 11.

FIG. 12 illustrates a process of checking whether coordinates of a point on a Bezier curve currently being output are identical to coordinates of the end control point according to one or more example embodiments.

Referring to FIG. 12, in operation 1210, whether the coordinates of the point on the Bezier curve currently being output correspond to t=0 or t=1 may be determined, while t is being increased or decreased.

When the coordinates of the point on the Bezier curve correspond to t=0 or t=1, the operation 1104 may be performed.

Conversely, when the coordinates of the point on the Bezier curve do not correspond to t=0 or t=1, whether t corresponds to t=α or t=β may be determined in operation 1220.

By determining whether t corresponds to t=α or t=β, whether t corresponds to a boundary value may be determined.

When it is determined that t corresponds to t=α or t=β, the operation 1104 may be performed. When it is determined that t does not correspond to t=α or t=β, the operation 1105 may be performed.

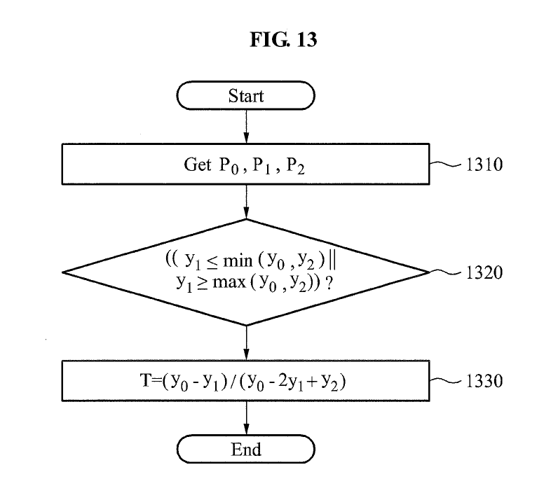

FIG. 13 illustrates an operating method of a T generator according to one or more example embodiments, such as the T generator 1030 of FIG. 10.

The T generator 1030 may calculate a time value t at an extremal value point on a Bezier curve.

In particular, the T generator 1030 may get three points P₀, P₁, and P₂, in operation 1310. The T generator 1030 may determine whether y₁ is less than or equal to y₀ and y₂, or greater than or equal to y₀ and y₂, in operation 1320.

When y₁ is less than or equal to y₀ and y₂, the T generator 1030 may generate T through a concave Bezier curve, in operation 1330.

When y₁ is greater than or equal to y₀ and y₂, the T generator 1030 may generate T through a convex Bezier curve, in operation 1330.

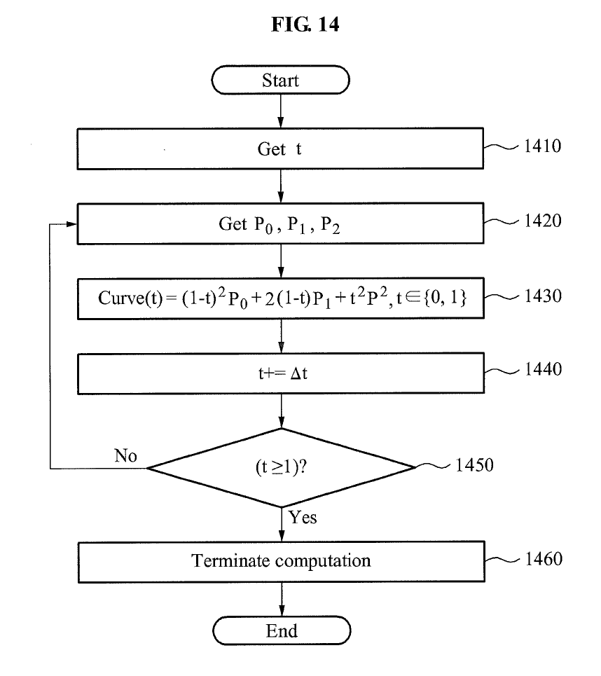

FIG. 14 illustrates an operating method of a Bezier calculator according to one or more example embodiments, such as the Bezier calculator 1040 of FIG. 10.

The Bezier calculator 1040 may calculate an interpolated polynomial expression derived by a definition of a Bezier curve.

To this end, the Bezier calculator 1040 may get a time value t, and return coordinates of the Bezier curve.

In particular, the Bezier calculator 1040 may get the time value t from a tile binner, in operation 1410. The Bezier calculator 1040 may get three points P₀, P₁, and P₂, in operation 1420.

In operation 1430, the Bezier calculator 1040 may generate a Bezier curve curve(t), using the three points P₀, P₁, and P₂.

In operation 1440, the Bezier calculator 1040 may increase an initial t by Δt. In operation 1450, the Bezier calculator 1040 may determine whether t is greater than or equal to “1”

When it is determined that t is greater than or equal to “1”, the Bezier calculator 1040 may determine that t corresponds to an end control point, and terminate computation of the Bezier curve, in operation 1460. When t is less than “1”, the Bezier calculator 1040 may return to the operation 1420.

When an apparatus and method of rendering a Bezier curve is used, a time-consuming process of partitioning a curve may be unnecessary for a curve drawing in multiple tiles in a TBR graphic processing unit (GPU) structure. In addition, curve rendering may be performed effectively without overhead of Bezier computation being duplicated for each tile.

Although the method according to the above-described example embodiments has been described with respect to a cubic Bezier curve, the method is not limited to the cubic Bezier curve. Instead, the method may be applied to a quartic or higher dimensional Bezier curve since the cubic Bezier curve is interconvertible with the quartic or higher dimensional Bezier curves.

Data files of TrueType Font constituting Bezier curves, Scalable Vector Graphics (SVG) corresponding to an image standard of Hyper Text Markup Language 5 (HTML5), PostScript corresponding to one of document standards, Portable Document Format (PDF), Adobe Flash corresponding to effective animation, and Microsoft SilverLight may include curve drawing instructions. Through effective GPU-acceleration of such curve drawing, performance may be improved effectively.

In one or more embodiments, any apparatus, system, element, or interpretable unit descriptions herein include one or more hardware devices or hardware processing elements. For example, in one or more embodiments, any described apparatus, system, element, retriever, pre or post-processing elements, tracker, detector, encoder, decoder, etc., may further include one or more memories and/or processing elements, and any hardware input/output transmission devices, or represent operating portions/aspects of one or more respective processing elements or devices. Further, the term apparatus should be considered synonymous with elements of a physical system, not limited to a single device or enclosure or all described elements embodied in single respective enclosures in all embodiments, but rather, depending on embodiment, is open to being embodied together or separately in differing enclosures and/or locations through differing hardware elements.

In addition to the above described embodiments, embodiments can also be implemented through computer readable code/instructions in/on a non-transitory medium, e.g., a computer readable medium, to control at least one processing device, such as a processor or computer, to implement any above described embodiment. The medium can correspond to any defined, measurable, and tangible structure permitting the storing and/or transmission of the computer readable code.

The media may also include, e.g., in combination with the computer readable code, data files, data structures, and the like. One or more embodiments of computer-readable media include: magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Computer readable code may include both machine code, such as produced by a compiler, and files containing higher level code that may be executed by the computer using an interpreter, for example. The media may also be any defined, measurable, and tangible distributed network, so that the computer readable code is stored and executed in a distributed fashion. Still further, as only an example, the processing element could include a processor or a computer processor, and processing elements may be distributed and/or included in a single device.

The computer-readable media may also be embodied in at least one application specific integrated circuit (ASIC) or Field Programmable Gate Array (FPGA), as only examples, which execute (e.g., processes like a processor) program instructions.

While aspects of the present invention has been particularly shown and described with reference to differing embodiments thereof, it should be understood that these embodiments should be considered in a descriptive sense only and not for purposes of limitation. Descriptions of features or aspects within each embodiment should typically be considered as available for other similar features or aspects in the remaining embodiments. Suitable results may equally be achieved if the described techniques are performed in a different order and/or if components in a described system, architecture, device, or circuit are combined in a different manner and/or replaced or supplemented by other components or their equivalents.

Thus, although a few embodiments have been shown and described, with additional embodiments being equally available, it would be appreciated by those skilled in the art that changes may be made in these embodiments without departing from the principles and spirit of the invention, the scope of which is defined in the claims and their equivalents.

What is claimed is:

1. A tile-based curve rendering apparatus for rendering a tile-binned Bezier curve, the apparatus comprising:
a rendering calculator to determine a rendering scheme for at least one tile, with respect to the tile-binned Bezier curve; and
a rendering processor to perform rendering with respect to a Bezier curve for the at least one tile, based on the determined rendering scheme,
wherein the rendering calculator suspends the rendering of the Bezier curve at a boundary point between the at least one tile and an adjacent tile while the rendering is being performed, and determines the rendering scheme for a boundary value in which a position of the boundary point is reflected to be used when the adjacent tile is rendered.

2. The apparatus of claim 1, wherein the rendering calculator verifies whether at least one of a start control point, an extremal value point, and an end control point of the Bezier curve is present in a tile to be rendered.

3. The apparatus of claim 1, wherein, when at least one of a start control point and an end control point of the Bezier curve is present in a tile to be rendered, the rendering calculator determines the rendering scheme for the rendering of the Bezier curve to be terminated on at least one of the start control point and the end control point.

4. The apparatus of claim 1, wherein, when an extremal value point of the Bezier curve is present in a tile to be rendered, the rendering calculator determines the rendering scheme for the rendering of the Bezier curve to be performed, starting from the extremal value point to at least one of the boundary point between the at least one tile and an adjacent tile, a start control point, and an end control point.

5. The apparatus of claim 2, wherein the rendering calculator verifies whether coordinates of the extremal value point are present in the tile to be rendered, using a ratio of the extremal value point to three points constituting the Bezier curve.

6. The apparatus of claim 1, wherein the rendering calculator determines the rendering scheme for the Bezier curve to be rendered starting from the boundary value, when the Bezier curve is rendered in the adjacent tile.

7. A tile-based curve rendering method performed by an apparatus for rendering a tile-binned Bezier curve, the method comprising:
determining, by a rendering calculator, a rendering scheme for at least one tile, with respect to the tile-binned Bezier curve; and
performing, by a rendering processor, rendering with respect to a Bezier curve for the at least one tile, based on the determined rendering scheme,
wherein the determining comprises suspending the rendering of the Bezier curve at a boundary point between the at least one tile and an adjacent tile while the rendering is being performed, and determining the rendering scheme for a boundary value in which a position of the boundary point is reflected to be used when the adjacent tile is rendered.

8. The method of claim 7, wherein the determining comprises verifying whether at least one of a start control point, an extremal value point, and an end control point of the Bezier curve is present in a tile to be rendered.

9. The method of claim 7, wherein the determining comprises, when at least one of a start control point and an end control point of the Bezier curve is present in a tile to be rendered, determining the rendering scheme for the rendering of the Bezier curve to be terminated on at least one of the start control point and the end control point.

10. The method of claim 7, wherein the determining comprises, when an extremal value point of the Bezier curve is present in a tile to be rendered, determining the rendering scheme for the rendering of the Bezier curve to be performed, starting from the extremal value point to at least one of the boundary point between the at least one tile and an adjacent tile, a start control point, and an end control point.

11. The method of claim 8, wherein the determining comprises verifying whether coordinates of the extremal value point are present in the tile to be rendered, using a ratio of the extremal value point to three points constituting the Bezier curve.

12. The method of claim 7, wherein the determining comprises determining the rendering scheme for the Bezier curve to be rendered starting from the boundary value, when the Bezier curve is rendered in the adjacent tile.

13. A tile-based curve rendering method performed by an apparatus for rendering a tile-binned Bezier curve, the method comprising:
suspending rendering of a Bezier curve for at least one tile at a boundary point between at the least one tile and an adjacent tile while the rendering is being performed, and determining a rendering scheme for a boundary value in which a position of the boundary point is reflected to be used when the adjacent tile is rendered.

14. The method of claim 13, further comprising:
determining, by a rendering calculator, a rendering scheme for at least one tile, with respect to the tile-binned Bezier curve; and
performing, by a rendering processor, rendering with respect to a Bezier curve for the at least one tile, based on the determined rendering scheme.

15. The method of claim 14, wherein the determining comprises verifying whether at least one of a start control point, an extremal value point, and an end control point of the Bezier curve is present in a tile to be rendered.

16. The method of claim 14, wherein the determining comprises, when at least one of a start control point and an end control point of the Bezier curve is present in a tile to be rendered, determining the rendering scheme for the rendering of the Bezier curve to be terminated on at least one of the start control point and the end control point.

17. The method of claim 14, wherein the determining comprises, when an extremal value point of the Bezier curve is present in a tile to be rendered, determining the rendering scheme for the rendering of the Bezier curve to be performed, starting from the extremal value point to at least one of the boundary point between the at least one tile and an adjacent tile, a start control point, and an end control point.

18. The method of claim 15, wherein the determining comprises verifying whether coordinates of the extremal value point are present in the tile to be rendered, using a ratio of the extremal value point to three points constituting the Bezier curve.

19. The method of claim 14, wherein the determining comprises determining the rendering scheme for the Bezier curve to be rendered starting from the boundary value, when the Bezier curve is rendered in the adjacent tile.
